(19) United States
(12) Patent Application Publication
(10) Pub. No.: US 2008/0218891 A1
(43) Pub. Date: Sep. 11, 2008

(54) Magnetic recording device with an integrated microelectronic device

(75) Inventors: Mark Anthony Gubbins, Letterkenny (IE); Ge Yi, Londonderry (IE); Marcus Benedict Mooney, Quigleys Point (IE); Xin Cao, Londonderry (IE)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/715,103

(22) Filed: Mar. 7, 2007

(51) Int. Cl. G11B 5/02

(52) U.S. Cl. 360/59; 360/55

(57) ABSTRACT

A system includes a magnetic recording device and a circuit including at least one active semiconductor component. The circuit is formed on the magnetic recording device and generates an output associated with operation of the magnetic recording device.

### BACKGROUND OF THE INVENTION

The present invention relates to magnetic devices. More particularly, the present invention relates to a magnetic recording device including integrated microelectronic devices for monitoring and recording applications.

Advances in magnetic recording head technology are driven primarily by a requirement for increased bit density in the hard drive, which is the number of bits that can be written to the storage medium in a given length, area, or volume. In addition to increased bit density, reliability, data rate, and repeatability are important considerations in the performance of the magnetic recording head. At existing high bit densities, nanometer level head media spacing, and gigabit data rates, increasing the number of functions executed in the recording head will have overall drive level benefits. The ability to integrate signal processing, power delivery, and sensor systems into the recording head has substantial advantages for future recording head technologies.

### BRIEF SUMMARY OF THE INVENTION

The present invention relates to a system including a magnetic recording device and a circuit including at least one active semiconductor component. The circuit is formed on the magnetic recording device and generates an output associated with operation of the magnetic recording device.

### BRIEF DESCRIPTION OF THE DRAWINGS

FIG. 1 is a cross-section view of a transducing head including an integrated microelectronic device.

FIG. 2 shows an example configuration of a transistor suitable for use in the microelectronic circuit integrated with the transducing head.

FIG. 3 shows an example-configuration of a diode suitable for use in the microelectronic circuit integrated with transducing head.

FIG. 4 is a cross-section view of a writer portion of the transducing head including an integrated semiconductor oscillation circuit to generate a write assist field.

FIG. 5 is a schematic of the semiconductor oscillator circuit for providing a time-varying current used to generate the write assist field.

FIG. 6 is a cross-section view of the transducing head including an integrated semiconductor heater circuit for controlling the distance between the transducing head and a magnetic medium.

FIG. 7 is a schematic of the semiconductor heater circuit shown in FIG. 6.

FIG. 8 is a cross-section view of the transducing head including an integrated semiconductor temperature sensor for monitoring the spacing between the transducing head and the magnetic medium.

FIG. 9 is a schematic of the semiconductor temperature sensor shown in FIG. 8.

FIG. 10 is a graph showing the relationship between temperature and resistance across the temperature sensor shown in FIG. 9.

FIG. 11 is a cross-section view of the transducing head including an integrated semiconductor optical source for providing an optical signal employed to heat a portion of the magnetic medium.

### DETAILED DESCRIPTION

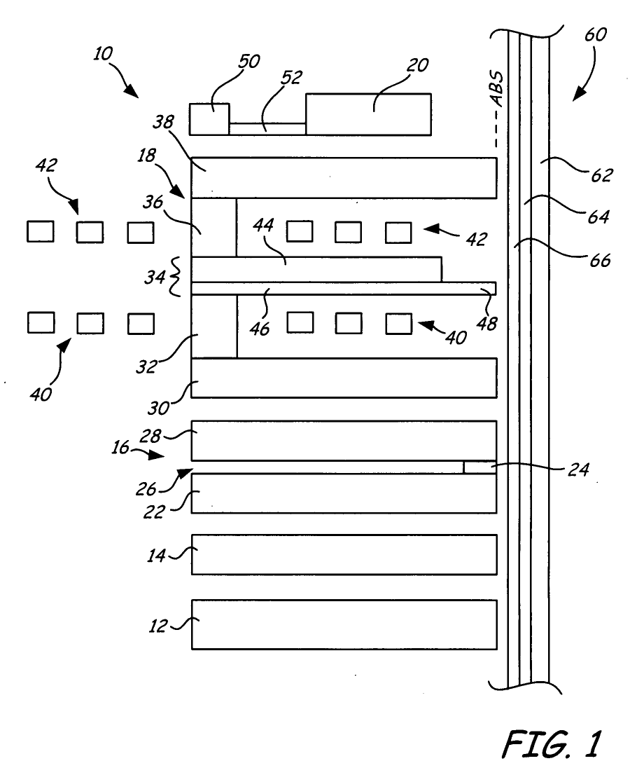

FIG. 1 is a cross-sectional view of transducing head 10, which includes substrate 12, basecoat 14, reader 16, writer 18, and microelectronic device 20. Reader 16 includes bottom shield structure 22, read element 24, read gap 26, and top shield structure 28. Writer 18 includes first return pole 30, first magnetic stud 32, main pole 34, second magnetic stud 36, second return pole 38, first conductive coil 40, and second conductive coil 42. Main pole 34 includes yoke 44 and main pole body 46 including main pole tip 48. Microelectronic device 20 is connected to a conductive pad or pads 50 via interconnect 52. Also shown in FIG. I is conductive element 50, which may be incorporated for use in conjunction with certain embodiments of microelectronic device 20.

Transducing head 10 confronts magnetic medium 60 at an air bearing surface (ABS). Magnetic medium 60 includes substrate 62, soft underlayer (SUL) 64, and medium layer 66. SUL 64 is disposed between substrate 62 and medium layer 66. Magnetic medium 60 is positioned proximate to transducing head 10 such that the surface of medium layer 66 opposite SUL 64 faces reader 16 and writer 18. Magnetic medium 60 is shown merely for purposes of illustration, and may be any type of medium that can be used in conjunction with transducing head 10, such as composite media, continuous/granular coupled (CGC) media, discrete track media, and bit-patterned media.

Basecoat 14 is deposited on substrate 12. Substrate 12 is typically formed of a material such as AlTiC, TiC, Si, SiC, Al₂O₃, or other composite materials formed of combinations of these materials. Basecoat 14 is generally formed of an insulating material, such as Al₂O₃, AlN, SiO₂, Si₃N₄, or SiO₀₋₂N_{0-1.5}. Generally the insulating material for basecoat 14 is selected to most closely match the chemical and mechanical properties of the material used as substrate 12.

Reader 16 and writer 18 are each multi-layered devices, which are stacked upon basecoat 14 adjacent the ABS of transducing head 10. Reader 16 is formed on basecoat 14, and writer 18 is stacked on reader 16 in a piggyback configuration in which layers are not shared between the two elements. In other embodiments not illustrated, reader 16 and writer 18 may be arranged in a merged-head configuration (in which layers are shared between the two elements) and/or writer 18 may be formed on basecoat 14, with reader 16 being formed on writer 18.

Read gap 26 is defined on the ABS between terminating ends of bottom shield 22 and top shield 28. Read element 24 is positioned in read gap 26 adjacent the ABS. Read gap 26 insulates read element 24 from bottom shield 22 and top shield 28. Read element 24 may be any variety of different types of read elements, such as a tunneling magnetoresistive (TMR) read element or a giant magnetoresistive (GMR) read element. In operation, magnetic flux from a surface of magnetic medium 60 causes rotation of a magnetization vector of read element 24, which in turn causes a change in electrical resistivity of read element 24. The change in resistivity of read element 24 can be detected by passing a current through read element 24 and measuring a voltage across read element 24. Shields 22 and 28, which may be made of a soft ferromagnetic material, guide stray magnetic flux from medium layer 66 away from read element 24 outside the area of medium layer 66 directly below read element 24.

In writer 18, first return pole 30, second return pole 38, first magnetic stud 32, and second magnetic stud 36 may comprise soft magnetic materials, such as NiFe. Conductive coils 40 and 42 may comprise a material with low electrical resistance, such as Cu. Main pole body 46 may comprise a high moment soft magnetic material, such as CoFe. Yoke 44 may comprise a soft magnetic material, such as NiFe or CoNiFe, to improve the efficiency of flux delivery to main pole body 34. First conductive coil 40 surrounds first magnetic stud 32, which magnetically couples main pole 34 to first return pole 30. Second conductive coil 42 surrounds second magnetic stud 36, which magnetically couples main pole 34 to second return pole 38. First conductive coil 40 passes through the gap between first return pole 30 and main pole 34, and second conductive coil 42 passes through the gap between main pole 34 and second return pole 38.

Reader 16 and writer 18 are carried over the surface of magnetic medium 60, which is moved relative to transducing head 10 as indicated by arrow A such that main pole 34 trails first return pole 30, leads second return pole 38, and is used to physically write data to magnetic medium 60. In order to write data to magnetic medium 60, current is caused to flow through second conductive coil 42. The magnetomotive force in the coils causes magnetic flux to travel from main pole tip 48 perpendicularly through medium layer 66, across SUL 64, and through second return pole 38 and first magnetic stud 36 to provide a closed magnetic flux path. The direction of the write field at the medium confronting surface of main pole tip 48, which is related to the state of the data written to magnetic medium 60, is controllable based on the direction that the current flows through second conductive coil 30.

Stray magnetic fields from outside sources, such as a voice coil motor associated with actuation of transducing head 10 relative to magnetic medium 60, may enter SUL 64. Due to the closed magnetic path between main pole 34 and second return pole 38, these stray fields may be drawn into writer 18 by second return pole 38. In order to reduce or eliminate these stray fields, first return pole 30 is connected to main pole 34 via first magnetic stud 32 to provide a flux path for the stray magnetic fields. In addition, the strength of the write field through main pole 34 may be increased by causing current to flow through first conductive coil 40. The magnetomotive force in the coils causes magnetic flux to travel from main pole tip 48 perpendicularly through medium layer 66, across SUL 64, and through first return pole 30 and first magnetic stud 32 to provide a closed magnetic flux path. The direction of the current through first conductive coil 40 is opposite that of the current through conductive coil 42 to generate magnetic flux in the same direction through main pole 34. The effect of employing two return poles and two conductive coils is an efficient driving force to main pole 34, with a reduction on the net driving force on first return pole 30 and second return pole 38.

Writer 18 is shown merely for purposes of illustrating a construction that may be used in a transducing head 10 including an integrated microelectronic device 20, and variations on the design may be made. For example, while main pole 34 includes yoke 44 and main pole body 46, main pole 34 can also be comprised of a single layer of magnetic material. Also, while two planar coils 40 and 42 are shown disposed around respective magnetic studs 32 and 36, a single helical coil may alternatively be disposed around main pole 34. In addition, a single trailing return pole may be provided instead of the shown dual return pole writer configuration. Furthermore, writer 18 is configured for writing data perpendicularly to magnetic medium 60, but writer 18 and magnetic medium 60 may also be configured to write data longitudinally.

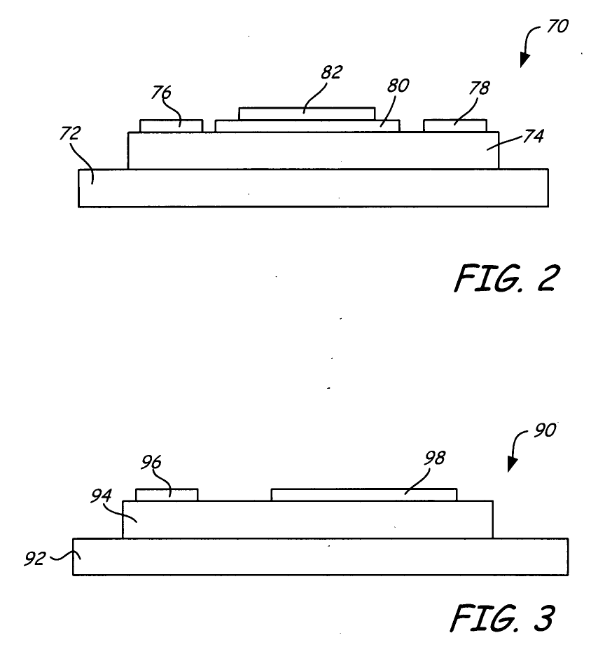

Microelectronic device 20 is integrated into transducing head 10 to provide an output related to the operation of transducing head 10. In various embodiments, microelectronic device 20 includes at least one active semiconductor component. An active semiconductor component is any semiconductor device that has gain and/or switches current flow (e.g., diodes and transistors). Power may be supplied to microelectronic device 20 via pad 50, which is connected to microelectronic device 20 by interconnect 52. The ability to add microelectronic device 20 including active and passive semiconductor components to transducing head 10 allows the head to monitor its environment and improve its performance while complementing other drive functions. Example microelectronic devices that may be integrated into transducing head 10 will be described with regard to FIGS. 2-5. While microelectronic device 20 is shown on top of writer 18 and recessed from the ABS, microelectronic device 20 may be integrated anywhere in transducing head 10, such as between reader 16 and writer 18, between basecoat 14 and reader 16, on a side of transducing head 10 opposite the ABS, or adjacent to the ABS.

Microelectronic device 20 may be integrated into transducing head 10 either by fabricating microelectronic device 20 during the build process for transducing head 10 or by separately manufacturing transducing head 10 and microelectronic device 20 and then joining them together. In the former case, thin film transistors and diodes can be fabricated during the manufacturing process of transducing head 10 using conventional deposition and patterning techniques. Thin film transistors can be fabricated using such materials as Si, poly Si, SiGe, GaAs, InP, ZnO, SnO₂, or any other semiconductor materials in thin film form. Such devices can be combined to form electric circuits of varying complexity to carry out functions in transducing head 10. Diodes can also be fabricated in thin film form using the materials listed for transistor fabrication. The diodes can be p-n junction diodes, Schottky diodes, or any other type of semiconductor rectifying device that can be used in rectifying circuit configurations to regulate signal transmission and power flow in transducing head 10.

A separately fabricated microelectronic circuit 20 may also be positioned and bonded to transducing head 10 either during or after fabrication of transducing head 10. One advantage of this approach is that microelectronic circuits 20 can be processed and integrated with transducing head 10 after processing of these components individually. For example, wafer-to-wafer bonding can be used to bond a microelectronic circuit 20 fabricated on a wafer to a transducing head 10 formed on a separate wafer.

FIG. 2 shows an example configuration of a transistor 70 that is suitable for use in microelectronic circuit 20 and integration with transducing head 10. Transistor 70 includes substrate 72, semiconductor thin-film layer 74, source contact 76, drain contact 78, gate insulator 80, and gate contact 82. In order to be compatible with fabrication process for transducing head 10, substrate 72 and semiconductor thin-film layer 74 may be a polycrystalline or amorphous material. Source contact 76 and drain contact 78, which may be metallic thin-film structures, are formed on semiconductor thin-film layer 74. Gate insulator 80 is formed on semiconductor thin-film layer 74 between source contact 76 and drain contact 78, and gate contact 82 is formed on gate insulator 80. A voltage applied to gate insulator 80 regulates current flow across semiconductor thin-film layer 74 between source contact 76 and drain contact 78.

FIG. 3 shows an example configuration of a Schottky diode 90 that is suitable for use in microelectronic circuit 20 and integration with transducing head 10. Diode 90 includes substrate 92, semiconductor thin-film layer 94, ohmic contact 96, and Schottky contact 98. In order to be compatible with fabrication process for transducing head 10, substrate 92 and semiconductor thin-film layer 94 may be a polycrystalline or amorphous material. Ohmic contact 96 and Schottky contact 98, which may be formed of a metallic material, are formed on semiconductor thin-film layer 94. When a voltage having a first polarity is applied across ohmic contact 96 and Schottky contact 98, current flows freely between ohmic contact 96 and Schottky contact 98 across semiconductor thin-film layer 94. When a voltage having a second polarity opposite the first polarity is applied across ohmic contact 96 and Schottky contact 98, current is blocked due to the rectifying nature of Schottky contact 98.

### High Frequency Oscillator

In order to write data to the high coercivity medium layer 66 of magnetic medium 60 with a lower write field, a high frequency write assist field may be generated at magnetic medium 60 proximate to main pole 34. According to the Stoner-Wohlfarth model, the switching field limit of the uniformly magnetized grains in medium layer 34 may be expressed as:

$${h}_{sw} ( θ ) = \frac{1}{{( {cos}^{2 / 3} ( θ ) + {sin}^{2 / 3} ( θ ) )}^{3 / 2}} , \qquad ( Equation 1 )$$

where h_{sw}, is the write field required to switch the magnetization direction of the grains in medium layer 66 and θ is the write field angle with respect to the easy axis anisotropy of the grains of medium layer 66. At near perpendicular write field angles, the write field required to impress magnetization reversal in the grains medium layer 66 is only slightly less than the easy axis anisotropy field. Thus, for a high coercivity medium, the write field required for reversal can be very high. However, research has shown that when a high frequency field is generated at magnetic medium 60, the field required to impress grain magnetization reversal is reduced significantly below that predicted by the Stoner-Wohlfarth model. Consequently, the coercivity of the medium layer 66 may be reduced by generating a high frequency field in medium layer 66 close to the write field generated by write pole 34 in magnetic medium 60.

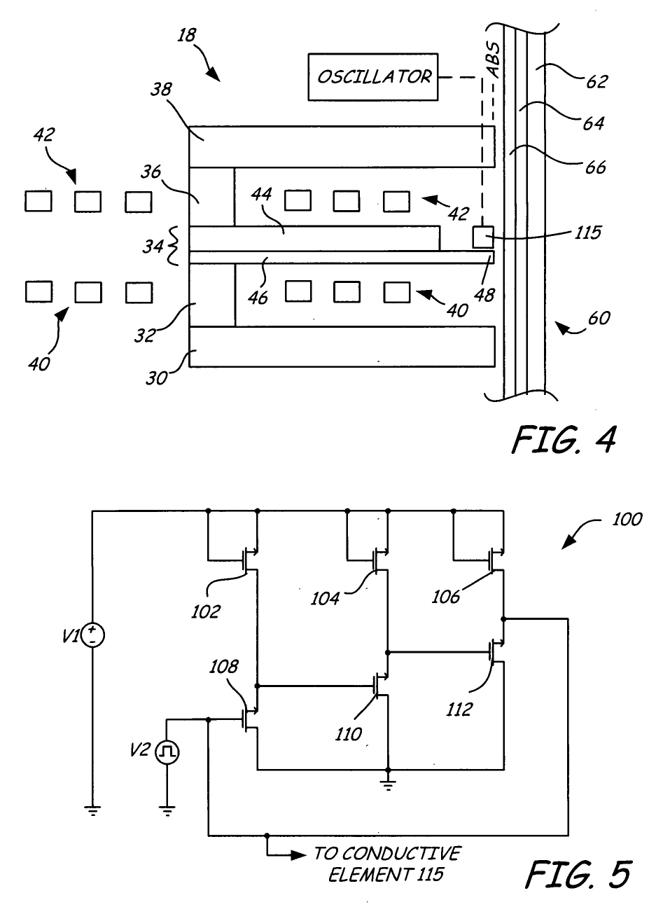

FIG. 4 is a cross-section view of writer 18 including an integrated semiconductor oscillation circuit 100 to generate a high frequency field at magnetic medium 60, and FIG. 5 is a schematic view of an embodiment of oscillation circuit 100. Oscillation circuit 100 includes voltage source V1, voltage source V2, and thin film transistors 102, 104, 106, 108, 110, and 112. The thin film transistors are arranged to provide three inverters connected in series, wherein transistors 102, 104, and 106 are active load transistors and transistors 108, 110, and 112 are inverting transistors. In various embodiments, transistors 102, 104, 106, 108, 110, and 112 are field effect transistors. The gate and drain of the active load transistors are connected to voltage source V1 and the source of each active load transistor is connected to the drain of each inverting transistor. The gate of transistor 108 is connected to voltage source V2, the gate of transistor 110 is connected to the drain of transistor 78, and the gate of transistor 112 is connected to the drain of transistor 110. The source terminals of each inverting transistor is connected to ground, and conductive element 115 is connected to voltage source V2 and the drain of transistor 82. Oscillation circuit 100 is shown generally as a block in FIG. 4 for ease of illustration, but in implementation includes transistors 102, 104, 106, 108, 110, and 112 patterned on top of writer 18. It should be noted that oscillation circuit 100 is merely exemplary, and any circuit capable of producing an oscillating current employed to generate a write assist field may alternatively be integrated with transducing head 10.

When power supply V1 is enabled, the voltage at the drains and gates of transistors 102, 104, and 106, as well as the voltage at the drains of transistors 108, 110, and 112, is raised from zero to approximately the voltage supplied by power supply V1. The source terminals of transistors 108, 110, and 112 are maintained at ground. Subsequently, when a voltage pulse is supplied by voltage supply V2, the resulting voltage at the drain of transistor 108 is changed to a voltage equal but opposite in polarity to the voltage applied at the gate of transistor 108. This inverted voltage is applied to the gate of transistor 110, which causes the voltage at the drain of transistor 110 to change to a voltage equal but opposite in polarity to the gate voltage. This inverted voltage is applied at the gate of transistor 112, which causes the voltage at the drain of transistor 112 to change to a voltage equal but opposite in polarity to the gate voltage. The drain voltage of transistor 112 is supplied to the gate of transistor 108, which begins the transfer of inverted voltages through the circuit again. In this way, a repeat oscillation of the voltage between transistors 108, 100, and 112 is maintained.

Conductive element 115 may be connected to any of the drains of inverting transistors 108, 110, or 112. In the embodiment shown, conductive element 115 is connected to the drain of transistor 112. The oscillating voltage in the integrated circuit causes an oscillating current to flow from oscillation circuit 100 through conductive element 115 parallel to the ABS, which produces an oscillating magnetic field. While the connection to conductive element 115 is illustrated as a single lead in FIG. 4 for the sake of clarity, in implementation a return path for the oscillating current would also be provided to allow the oscillating current to flow through conductive element 115. Conductive element 115 is placed proximate to main pole 34 to assist with recording at the trailing edge of main pole tip 48. The oscillating magnetic field augments the field from main pole 34 and results in improved writing and better system performance. In an alternative embodiment, oscillation circuit 100 and conductive element 115 are configured to generate a demagnetizing field to demagnetize main pole tip 48 while no information is being written to magnetic medium 60.

In order to be compatible with the manufacturing process of transducing head 10, oscillation circuit 100 may be designed to be compatible with an amorphous or polycrystalline substrate 12. The thin film transistors may include a patterned semiconductor thin film channel contacted at either end by ohmic electrodes. A conducting gate is positioned over the channel and separated from the channel by an insulating material. The semiconductor material may be comprised of Si, SiGe, ZnO, SnO₂, GaAs, or any other suitable material, and the electrodes may be comprised of Pd, Al, or any other suitable material. The oscillation frequency of oscillation circuit 100 depends on the distance between the drain and source of transistors 108, 120, and 122, and on the electron mobility of the channel layer in the thin film transistor.

### Transducing Head Heater

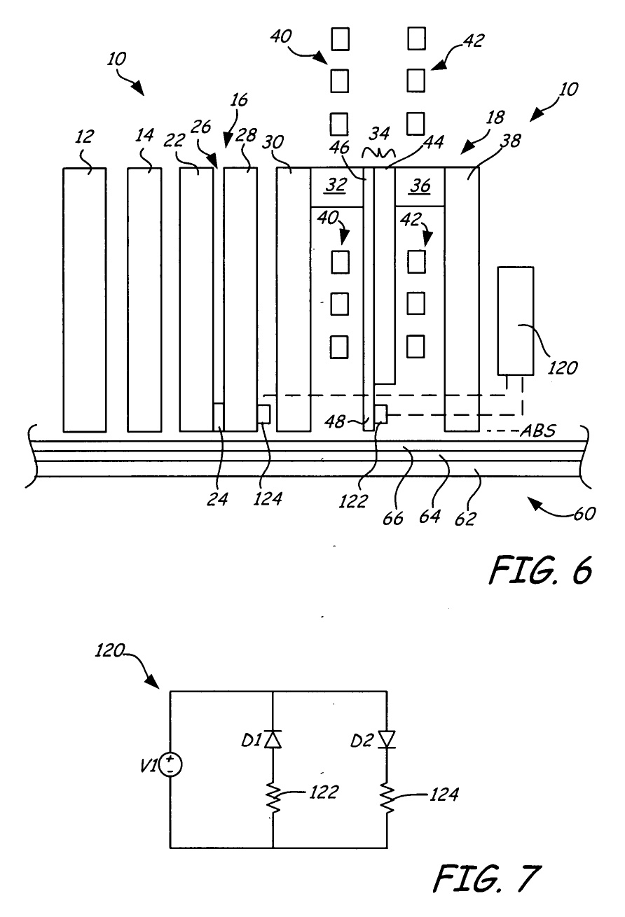

A heater may be integrated into transducing head 10 to control the distance or spacing between transducing head 10 and magnetic medium 60. Heating transducing head 10 (or portions thereof) causes it to expand and move closer to magnetic medium 60. It is desirable from a recording performance point of view to heat reader 16 and writer 18 separately. FIG. 6 is a cross-section view of transducing head 10 including an integrated microelectronic heater circuit 120 for controlling the distance between the transducing head 10 and a magnetic medium 60. FIG. 7 is a schematic of a microelectronic heater circuit 120, which includes voltage source V1, first diode D1, writer heater 122, second diode D2, and reader heater 124. The writer heater circuit includes diode D1 and writer heater 122 connected in series, and the reader heater circuit includes diode D2 and reader heater 124 are connected in series. The writer heater circuit and the reader heater circuit are connected in parallel across voltage source V1. Heater circuit 120 is shown generally as a block in FIG. 6 for ease of illustration, but in implementation would include diodes D1 and D2 patterned on top of writer 18. Also, in FIG. 6 writer heater 122 is shown disposed adjacent to main pole tip 48 and reader heater 124 is shown disposed adjacent to top shield 28, but writer heater 122 and reader heater 124 may alternatively be formed within layers of transducing head 10, or formed on a side of transducing head 10 opposite ABS.

When a negative voltage is supplied by voltage source V1, diode D1 is forward biased and current flows through writer heater 122, while diode D2 is reverse biased to prevent current from flowing though reader heater 124. On the other hand, when a positive voltage is supplied by voltage source V1, diode D2 is forward biased and current flows through reader heater 124, while diode D1 is reverse biased to prevent current from flowing though writer heater 122. Voltage source V1 is supplied externally from the components of transducing head 10 to limit interference with read or write operations or recorded data (e.g., via pad 50 shown in FIG. 1). An advantage of this design is that the reader and writer heater circuits can be controlled from a single voltage source V1, thus requiring only two contact pads for connecting an external voltage source to heater circuit 120.

Diodes D1 and D2 may be any of Schottky diodes, semiconductor pn junction diodes, p+n junction diodes, or any other type of electrically rectifying device. In order to be compatible with the manufacturing process of transducing head 10, the diode semiconductor material may include Si, SiGe, ZnO, SnO₂, or GaAs in polycrystalline or amorphous form. The metallic electrode of the diode may be comprised of Pd, Al, or any other suitable material that will form an electrically rectifying barrier at the surface of the semiconductor material.

### Head-to-Medium Spacing Sensor

The spacing between transducing head 10 and magnetic medium 60 is critical to the performance of the recording system. Thus, measurement and control of this spacing is very useful to controlling the performance and reliability of transducing head 10. As the distance between transducing head 10 and magnetic medium 60 changes, the rate of heat flow from transducing head 10 to magnetic medium 60 changes, and the temperature of transducing head 10 at the head-medium interface changed. An increase in the distance between transducing head 10 and magnetic medium 60 results in an increase in temperature in transducing head 10. This is due to the decreased cooling rate between transducing head 10 and magnetic medium 60 as the volume of gas between them increases.

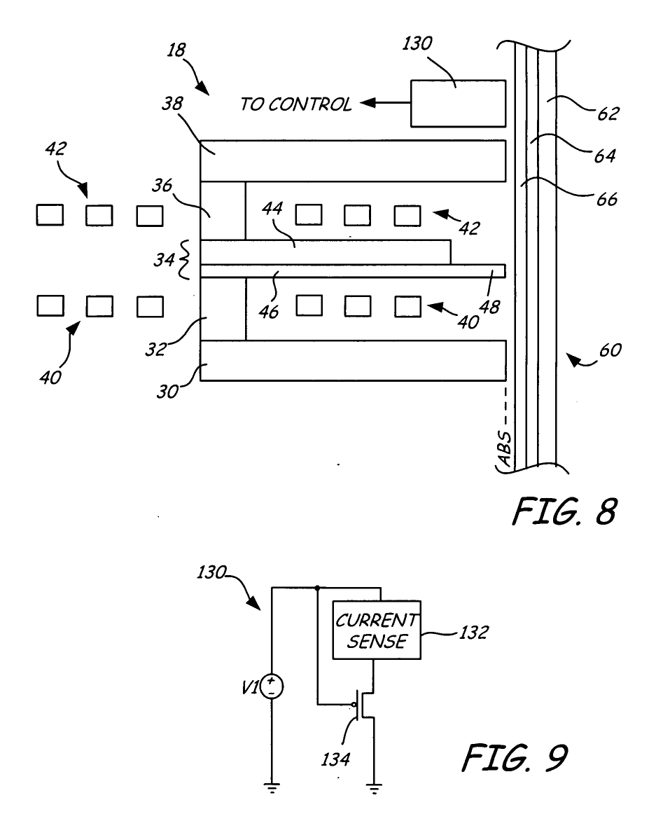

FIG. 8 is a cross-section view of writer 18 including an integrated microelectronic temperature sensor 130 for monitoring the spacing between the transducing head 10 and the magnetic medium 60. FIG. 9 is a schematic of microelectronic temperature sensor 130, which includes voltage source V1, current sensor 132, and transistor 134. The gate and drain of transistor 134 are connected voltage source V1, the source of transistor 134 is connected to ground, and current sensor 132 is connected between voltage source V1 and transistor 134 to measure the current flowing through transistor 134. Temperature sensor 130 is shown generally as a block in FIG. 8 for ease of illustration, but in implementation would include transistor 134 patterned on top of writer 18.

In order to monitor the change in temperature due to changes in the distance between transducing head 10 and magnetic medium 60, transistor 134 is integrated with transducing head 10 adjacent to the ABS. For example, transistor 134 may be disposed on top of writer 18 as shown in FIG. 8. Alternatively, transistor 134 may be formed within transducing head 10, such as between reader 16 and writer 18, or between reader 16 and basecoat 14. In order to be compatible with the manufacturing process of transducing head 10, temperature sensor 130 is made of polycrystalline or amorphous materials. For example, the thin film transistor channel may be comprised of Si, ZnO, SnO, or any other semiconductor thin film in polycrystalline or amorphous form.

When the temperature change is to be measured, voltage source V1 supplies a voltage across transistor 134. The current that flows through transistor 134 as a result of the applied voltage is measured and monitored by current sensor 132. The applied voltage and measured current across transistor 134 are translated into the resistance across transistor 134 by a positioning control system (not shown). By continuously monitoring changes in resistance across transistor 134, the change in temperature in transistor 134 (and transducing head 10) can be determined, which can be translated into changes in distance between transducing head 10 and magnetic medium 60. The positioning control system can make adjustments based on the measure spacing between transducing head 10 and magnetic medium 60 to maintain a constant spacing, thereby improving drive reliability.

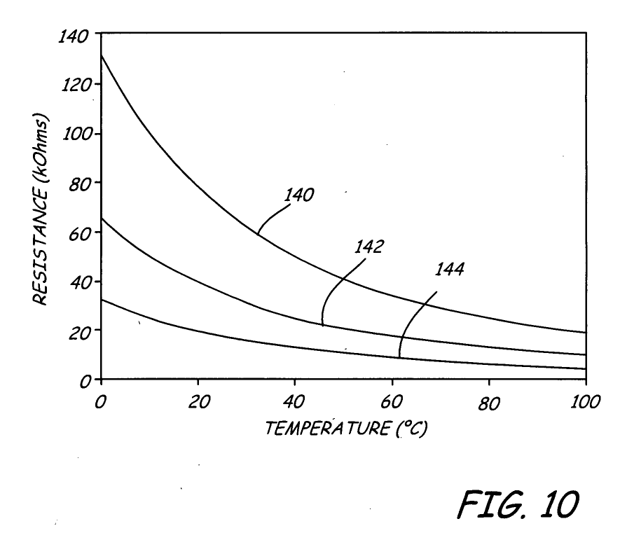

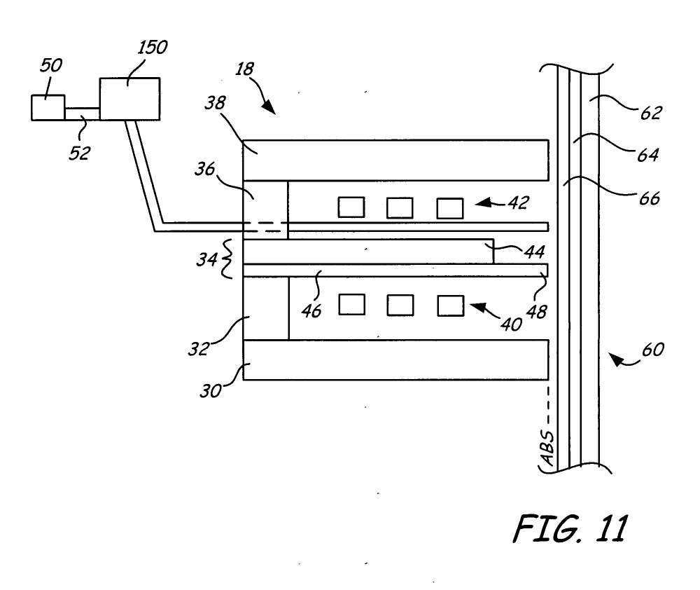

FIG. 10 is a graph showing simulation results of the relationship between temperature and resistance across transistor 134. The modeled transistor 134 was a polycrystalline thin film transistor with a temperature coefficient of resistance of 0.03/° C. Line 140 shows the results for the simulated transistor with an electron mobility across the transistor channel of 5 cm²/(V·s), line 142 shows the results of the simulated transistor with an electron mobility across the transistor channel of 10 cm²/(V·s), and line 144 shows the results of the simulated transistor with an electron mobility across the transistor channel of 20 cm²/(V·s). As can be seen, at normal operating temperatures the change in resistance across transistor 134 is substantial for even small changes in temperature. Thus, the separation between transducing head 10 and magnetic medium 60 can be measured very precisely using temperature sensor circuit 130.

### Heat Assisted Magnetic Recording

Heat assisted magnetic recording (HAMR) generally refers to the concept of locally heating magnetic medium 60 to reduce the coercivity of medium layer 66 so that the applied magnetic writing field can more easily direct the magnetization of medium layer 66 during the temporary magnetic softening of the medium layer 66 caused by the heat source. HAMR allows for the use of small grain media, which is desirable for recording at increased a real densities, with a larger magnetic anisotropy at room temperature to assure sufficient thermal stability. HAMR can be applied to any type of magnetic storage media, including tilted media, longitudinal media, perpendicular media and patterned media. By heating the medium, the Kᵤ or the coercivity is reduced such that the magnetic write field is sufficient to write to magnetic medium 60. Once magnetic medium 60 cools to ambient temperature, magnetic medium 60 has a sufficiently high value of coercivity to assure thermal stability of the recorded information.

FIG. 11 is a cross-section view of writer 18 including an integrated semiconductor optical source 150 for providing an optical signal employed to heat a portion of magnetic medium 60. Semiconductor optical source 150 is optically coupled to the ABS by waveguide 152 proximate to main pole 34. The optical signal from semiconductor optical source 150 is carried and focused by waveguide 152 at the ABS. Waveguide 152 outputs an optical spot on magnetic medium 60 that heats a portion of medium layer 66 proximate main pole 34. Semiconductor optical source 150 can be fabricated on or bonded to transducing head 10 using thin-film processing techniques.

Semiconductor optical source 150 may be a solid-state laser such as an edge-emitting laser or a vertical cavity surface emitting laser (VCSEL). A VCSEL is a type of semiconductor -laser diode with laser beam emission perpendicular from a top planar surface of the device, while an edge-emitting laser emits light from surfaces formed by cleaving individual edge-emitting lasers from a wafer. The laser resonator in a VCSEL consists of two mirrors each with an active region consisting of one or more quantum wells for laser light generation between the wells. The planar mirrors include layers of alternating high and low refractive indices, with each layer having a thickness of a quarter of the laser wavelength. The upper and lower are typically doped as p-type and n-type materials, thereby forming a diode junction.

In summary, the present invention relates to a system including a magnetic recording device and a circuit including at least one active semiconductor component. The circuit is formed on the magnetic recording device and generates an output associated with operation of the magnetic recording device. The ability to integrate microelectronic circuits including active and passive semiconductor devices into a magnetic recording device allows for monitoring of the device environment and improving performance of the device while complementing other drive functions.

Although the present invention has been described with reference to preferred embodiments, workers skilled in the art will recognize that changes may be made in form and detail without departing from the spirit and scope of the invention. For example, while three examples of microelectronic devices that may be integrated into a magnetic recording device have been described, microelectronic devices having any configuration or any function may also be integrated into the magnetic recording device, such as a semiconductor laser configured for providing heat assisted magnetic recording.

1. A system comprising:
a magnetic recording device; and
a circuit including at least one active semiconductor component, wherein the circuit is formed on a portion of the magnetic recording device, and wherein the circuit generates an output associated with operation of the magnetic recording device.

2. The system of claim 1, wherein the at least one active semiconductor component is selected from the group consisting of transistors, diodes, and combinations thereof.

3. The system of claim 1, wherein the at least one active semiconductor component is comprised of a material selected from the group consisting of Si, polysilicon, SiGe, InP, ZnO, SnO₂, GaAs, and combinations thereof.

4. The system of claim 1, wherein the circuit is selected from the group consisting of an oscillation device for generating a high frequency write assist field, a sensor for measuring a distance between the magnetic recording device and a magnetic medium, a heater for controlling a distance between the magnetic recording device and the magnetic medium, and an optical device that generates an optical signal for heating a portion of the magnetic medium.

5. The system of claim 4, wherein the magnetic recording device comprises a write element, and wherein the oscillation device comprises:
an oscillator circuit for generating a time-varying current; and
a conductive element disposed adjacent to the write element and electrically connected to the oscillator circuit for generating the high frequency write assist field.

6. The system of claim 5, wherein the oscillator circuit comprises a plurality of inverters connected in series.

7. The system of claim 4, wherein the sensor comprises a temperature sensor, and wherein the distance between the magnetic recording device and the magnetic medium is related a sensed temperature of the magnetic recording device.

8. The system of claim 7 wherein the temperature sensor comprises a transistor, and wherein the sensed temperature is related to a resistance across the transistor.

9. The system of claim 4, wherein the heater comprises a diode connected in series with a heating element.

10. The system of claim 9, wherein the magnetic recording device includes a writer portion and a reader portion, and wherein a heating element is associated with each of the writer portion and the reader portion.

11. The system of claim 10, wherein the diode associated with the reader heating element is forward biased when a current is applied in a first direction, and wherein the diode associated with the writer heating element is forward biased when the current is applied in a second direction opposite the first direction.

12. A system comprising:
a magnetic device for storing information to and reading information from a magnetic medium; and
a circuit adjoining the magnetic device that includes at least one active semiconductor component, wherein the circuit produces an output associated with operation of the magnetic device.

13. The system of claim 12, wherein the at least one active semiconductor component is selected from the group consisting of transistors, diodes, and combinations thereof.

14. The system of claim 12, wherein the at least one active semiconductor component is comprised of a material selected from the group consisting of Si, polysilicon, SiGe, InP, ZnO, SnO₂, GaAs, and combinations thereof.

15. The system of claim 12, wherein the circuit is selected from the group consisting of an oscillation device for generating a high frequency write assist field, a sensor for measuring a distance between the magnetic device and the magnetic medium, a heater for controlling a distance between the magnetic recording device and the magnetic medium, and an optical device that generates an optical signal for heating a portion of the magnetic medium.

16. The system of claim 15, wherein the magnetic device comprises a write element, and wherein the oscillation device comprises:
an oscillator circuit for generating a time-varying current; and
a conductive element disposed adjacent to the write element and electrically connected to the oscillator circuit for generating the high frequency write assist field.

17. The system of claim 16, wherein the oscillator circuit comprises a plurality of inverters connected in series.

18. The system of claim 15, wherein the sensor comprises a temperature sensor disposed proximate to the magnetic medium, and wherein the distance between the magnetic device and the magnetic medium is related a sensed temperature.

19. The system of claim 1 8, wherein the temperature sensor comprises a transistor, and wherein the sensed temperature is related to a resistance across the transistor.

20. The system of claim 15, wherein the heater comprises a diode connected in series with a heating element.

21. The system of claim 20, wherein the magnetic device includes a writer portion and a reader portion, and wherein a heating element is associated with each of the writer portion and the reader portion.

22. The system of claim 21, wherein the diode associated with the reader heating element is forward biased when a current is applied in a first direction, and wherein the diode associated with the writer heating element is forward biased when the current is applied in a second direction opposite the first direction.

23. A magnetic recording system comprising:
a writer portion for writing information to a magnetic medium;
a reader portion for reading information from a magnetic medium; and
a circuit including at least one active semiconductor device for producing an output employed by at least one of the writer portion and the reader portion, wherein the circuit is formed such that the writer portion, the reader portion, and the circuit form an integral assembly.

24. The magnetic recording system of claim 23, wherein the at least one active semiconductor component is selected from the group consisting of transistors, diodes, and combinations thereof.

25. The magnetic recording system of claim 23, wherein the circuit is selected from the group consisting of an oscillation device for generating a high frequency write assist field, a sensor for measuring a distance between the magnetic recording device and a magnetic medium, a heater for controlling a distance between the magnetic recording device and the magnetic medium, and an optical device that generates an optical signal for heating a portion of the magnetic medium.
